(19) United States
(12) Patent Application Publication
(10) Pub. No.: US 2009/0044569 A1
(43) Pub. Date: Feb. 19, 2009

(54) BUBBLING BRICK

(76) Inventors: Matthias Gorisch, Furth (DE); Hans Mahrenholtz, Hilgertshausen (DE)

Correspondence Address: The BOC Group, Inc., 575 MOUNTAIN AVENUE, MURRAY HILL, NJ, 07974-2082, US

(21) Appl. No.: 12/093,224

(22) PCT Filed: Nov. 28, 2006
(86) PCT No.: PCT/EP2006/011422

§ 371 Date: Oct. 14, 2008

(30) Foreign Application Priority Data
Dec. 7, 2005 (DE) 10 2005 058 452.7
Apr. 4, 2006 (EP) 06007145.3

(51) Int. Cl. C03B 5/16

(52) U.S. Cl. 65/134.4

(57) ABSTRACT

The invention pertains to a bubbling brick with at least two bores for introducing two different gases into a glass melt. In order to increase the variability of the glass melt process, these bores together form an included angle α>0.

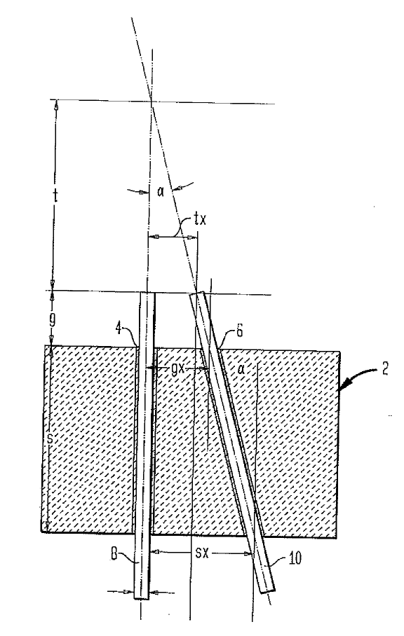

The invention pertains to a bubbling brick for introducing two different gases into a glass melt.

This bubbling brick is primarily used in refining inorganic compounds in molten form, particularly glass melts. In the manufacture of glass, it is necessary to carry out a refining process after the melting process. The refining serves for removing physically and chemically bound gases from the molten glass. The gases need to be removed so as to not impair the quality of the end product.

In addition to chemical refining processes, it is possible to purge the melt of gas components by purposefully introducing gas bubbles into the melt (bubbling), namely by injecting an external gas, and thusly causing a mass transfer. Due to the size of the bubbles, a forced convection is primarily realized in the melt. The driving force for the mass transfer from the melt into the bubble is the concentration difference between the concentration of the gases dissolved in the melt and the concentration of the gases in the bubble. The diffusion of gaseous components into the melt is associated with a growth of the bubble that increases the rate of ascent. A very effective mass transfer between the melt and the bubble is achieved due to a large specific surface (very large quantity of small bubbles).

A bubbling brick is known from DE 100 46 709 A1. This brick is referred to as a bubble dispenser in this publication and consists of a porous body that is arranged on the bottom of the glass trough and transports so-called miniature gas bubbles into the melt.

Bubbling with air has been known for many years and used for purposefully influencing the glass flow and ultimately the glass quality. The surrounding “cold” glass is transported to the surface by the ascending bubbles.

In certain instances, bubbling can also be carried out with pure oxygen rather than air, wherein this not only makes it possible to influence the glass flow in the above-described fashion, but also to prevent any influence of air components other than oxygen.

It has also been attempted to carry out bubbling with water vapor, but these attempts were unsuccessful because this water vapor withdraws energy from the glass melt and therefore advantageously affects the glass quality.

WO 2005/110933 A1 describes a device for refining glass, in which the bubbling brick is provided with two bores for introducing two different gases into the glass melt from the bottom. The two bores are arranged parallel to one another. One bore serves for transporting a flammable gas and the other bore serves for transporting oxygen. The gas bubbles combine within the glass melt above the bubbling brick such that the gas components react with one another. If hydrogen is introduced as the flammable gas, the resulting oxyhydrogen gas reaction introduces a relatively large amount of energy. The bubbles continue to ascend in the form of water vapor. In this device, the location of the reaction is relatively random and can hardly be influenced.

### SUMMARY OF THE INVENTION

The invention therefore is based on the objective of proposing a technical option for introducing two different gases into the bottom of a glass melt trough in such a way that the reaction zone can be geometrically defined or varied.

This objective is attained with a bubbling brick of the invention.

The inventive bubbling brick is characterized in that the two bores together form an acute included angle. This can be realized in that one bore extends straight and the other bore extends at an angle or in that both bores are inclined relative to one another and inclined relative to the vertical line. Due to these measures, the gases are combined at a defined location, at which, e.g., the oxyhydrogen gas reaction takes place if hydrogen and oxygen are used. The angle between the two bores is greater than 0° and lies between 5 and 40°, preferably between 10 and 20°.

In one embodiment of the invention, one or two displaceable nozzle tubes that preferably consist of a heat-resistant ceramic material are provided within the bores. This (these) tube(s) can be displaced inward and outward such that the height of the reaction point can be shifted. This makes it possible to optimally adapt the reaction to the requirements of the glass melt. The so-called bubbling brick therefore contains at least two bores that the inclined relative to one another at an acute angle such that their alignments intersect within the glass melt when the bubbling brick is inserted into the bottom of the glass melt trough.

One embodiment of the invention is illustrated in the FIGURE.

### DESCRIPTION OF THE INVENTION

The FIGURE shows the bubbling brick 2 with the two bores 4 and 6, wherein the bore 4 is realized vertically and the bore 6 is inclined by an angle α. The nozzle tubes 8 and 10 arranged within the bores 4 and 6 have a length that is greater than the thickness of the bubbling brick 2 and can be displaced upward and downward such that their tips can be adjusted to a certain height g within the glass melt. Due to these measures, the spacing of the gas outlets tₓ can be adapted to the glass melt conditions.

The following equations applied to the variables t, gₓ and α:

$$t = \frac{- g \cdot {t}_{x} - s \cdot {t}_{x}}{{t}_{x} - {s}_{x}}$$

$${g}_{x} = {t}_{x} + \frac{g \cdot {t}_{x}}{t}$$

$$α = arctan ( \frac{{s}_{x}}{t + g + s} )$$

One preferred spacing between the nozzles 8,10 lies between 30 and 60 mm. However, it would also be possible to use spacings between 20 and 100 mm. The diameter of the bores 4 or 6 preferably amounts to 15 mm. A few preferred dimensions are indicated in the following table:

| | | | |
|---|---|---|---|
| Minimum nozzle spacing | tx | mm | 30 |
| Maximum spacing from brick surface | g | mm | 150 |
| Spacing between outlets on brick surface | gx | mm | 63 |
| Brick thickness | s | mm | 350 |
| Bore spacing | sx | mm | 140 |
| Bore angle | α | ° | 12.4 |

Due to these measures, different spacings g between the outlet points and the brick surface are adjusted at different nozzle spacings tₓ. According to the following table

| tx′ | mm | 60 | 50 | 40 | 30 |
|---|---|---|---|---|---|
| g | mm | 13.6 | 59.1 | 105 | 150 |

the spacing tₓ therefore defines the reaction zone of the emerging gases that ascend in the glass melt.

1. A bubbling brick comprising at least two bores for introducing two different gases into a glass melt, the at least two bores together forming an angle α between 5 and 40°, preferably between 10 and 20°.

2. The bubbling brick according to claim 1, further comprising one or two nozzle tubes that can be displaced in the bores and which comprise ceramic material.

3. A brick constructed for introducing gases into a glass melt, comprising a brick having a first bore extending therethrough, and a first nozzle tube disposed in the first bore for movement with respect to the first bore and the glass melt and constructed to provide a first gas to the glass melt; a second bore extending through the brick, and a second nozzle tube disposed in the second bore for movement with respect to the second bore and the glass melt and constructed to provide a second gas to the glass melt; the first and second bores forming an angle between 5° and 40°.

4. The brick according to claim 3, wherein one of the first and second bores is disposed vertically within the brick.

5. The brick according to claim 3, wherein the first and second nozzle tubes each have a length greater than a thickness of the brick.

6. The brick according to claim 3, wherein the first nozzle tube and the second nozzle tube are displaceable to combine the first and second gases at a reaction zone in the glass melt.

7. The brick according to claim 3, wherein the first and second nozzle tubes each comprise ceramic material.
